(19) United States
(12) Patent Application Publication
(10) Pub. No.: US 2017/0210936 A1
(43) Pub. Date: Jul. 27, 2017

(54) POWDER COATINGS FOR HEAT SENSITIVE SUBSTRATES

(71) Applicant: Achiewell, LLC, North Wales, PA (US)

(72) Inventors: Jose Miguel Lorenzo, Allentown, PA (US); Jason Lucas Chou, Blue Bell, PA (US)

(21) Appl. No.: 15/413,596

(22) Filed: Jan. 24, 2017

Related U.S. Application Data
(60) Provisional application No. 62/388,307, filed on Jan. 25, 2016.

(51) Int. Cl. C09D 133/14; B05D 3/06; C08J 3/12; C08F 220/32; C09D 5/03

(52) U.S. Cl. CPC C09D 133/14; C08F 220/32; C09D 5/03; C08J 3/12; B05D 3/067; C08J 2333/14

(57) ABSTRACT

Powder coating compositions are disclosed that are suitable for low temperature curing yet provide coatings of desirable performance properties, equivalent to those previously attained only with coatings requiring a higher curing temperature. The powder coating compositions disclosed may be cured either by heat activated curing agents or by radiation activated curing agents.

### BACKGROUND OF THE INVENTION

This invention pertains to powder coating compositions for heat sensitive substrates. This invention also pertains to acrylic powder coating compositions that are capable of curing using photo-initiated or UV curing, instead of traditional thermal curing, to provide desirable coating performance properties.

Powder coating is the leading technology to coat metal surfaces such as automobile accessories, refrigerators, stoves, and washing machines. Powdered thermosetting compositions are widely used as paints and varnishes for coating various articles. One of the advantages of powdered coatings is the avoidance of volatile organic solvents which impart undesirable environmental, health and safety considerations. Additionally, any powders not adhering to the substrate being coated can potentially be recovered and reused. In the process for using powder coating compositions, the composition is applied to the substrate surface and then is cured, e.g., using photo-initiated curing and/or heat to effect cross-linking of polymer chains in the composition.

Traditionally, coating powders have been made by the extrusion of a mixture of resins and curing agents to obtain a homogeneous mixture and then grinding the extrudate and screening the comminuted product to obtain the desired particle sizes and particle size distribution. The powder is then electrostatically sprayed onto a substrate, traditionally a metal substrate, and cured at temperatures in the range of 150 degrees C. and higher.

Powder coating compositions containing resins made from epoxy functional methacrylate monomers have found significant commercial application. Most frequently, these compositions contain polymerized glycidyl methacrylate (GMA). GMA powder coatings have been used widely for over 35 years and are preferred among other powder coating systems, for example polyester, other epoxies, and combinations thereof. While these powder coating compositions have been found to provide excellent smoothness, crystal clarity, chemical resistance, high gloss, and durability, their applications have been essentially limited to coating metal surfaces due to the high temperatures that are required for achieving these coating properties. Typical curing temperatures for these powder coating compositions is in the range of 160 degrees C. to 190 degrees C. The use of lower curing temperatures with GMA-based powder coatings results in a deterioration of the cured coating properties. Another limitation of powder coating compositions based on GMA is that they cannot be cured using photo-initiated curing or UV-curing.

The dependence on high curing temperatures limits the substrates that can be coated using these GMA-containing coating compositions to those that have a very high melting point. Accordingly, GMA-containing coating compositions are not suitable for lower melting point substrates such as those comprised of polyethylene, polypropylene, polybutadiene, vinyl chloride, elastomers, and the like, where a high-performance coating is required. A substrate may also be unsuitable for high temperature curing if it is an assembly containing temperature sensitive components such as electronics or seals.

Accordingly, a need exists to provide powder coating compositions that are suitable for use on substrates that cannot be coated using high temperature cured coatings and that provide cured coating characteristics equivalent to high temperature cured coatings. Another important need is the development of acrylic powder coating compositions, which possess superior aesthetic properties such as gloss and smoothness, that can be cured using photo-initiated curing or UV-curing.

### SUMMARY OF THE INVENTION

It is an object of this invention, therefore, to provide powder coating compositions for heat sensitive substrates. It is a related object of this invention to provide a method for coating such substrates without the problems associated with volatile organic solvents. It is another object of this invention to provide a low temperature process for producing a smooth, durable and impact resistant coating on such substrates.

Another object of the invention is acrylic powder coating compositions that are capable of being cured using photo-initiated curing or UV-curing yet still can provide cured coating properties comparable to those achieved with GMA-containing compositions that are only curable at high temperatures.

These and other objects of the invention which will become apparent from the following description are achieved by a powder coating system in which the curing of a blend of: an epoxy resin formed from an epoxycycloaliphatic monomer; and a curing agent comprising: (A) a dicarboxylic acid thermosetting agent, or (B) a cationic photo-initiator. The powder coating compositions of the present invention are suitable for use on heat sensitive substrates because they can be cured using low temperature processes. The cured coatings produced using the compositions and methods disclosed herein yield finished surfaces with smoothness, durability and strength equal to the high temperature cured coatings of the prior art.

### BRIEF DESCRIPTION OF THE DRAWINGS

FIG. 1 is a graph showing the melting points of linear saturated dicarboxylic acids.

FIG. 2 is a graph showing the results of cross-cut adhesion tests performed according to ASTM D 3359 for coatings of the present invention and prior art cured at multiple temperatures.

FIG. 3 is a graph showing the results of toluene rub tests performed according to ASTM procedure 4752 on coatings of the present invention and the prior art cured at multiple temperatures.

FIG. 4 is a graph showing the results of conical mandrel bend tests performed according to ASTM D 522 for coatings of the present invention and prior art cured at multiple temperatures.

FIG. 5 is a graph showing the results of pencil hardness tests performed according to ASTM D 3363 for coatings of the present invention and prior art cured at multiple temperatures.

FIG. 6 is a graph showing differential scanning calorimetry results for coatings of the present invention and the prior art.

### DETAILED DESCRIPTION OF THE INVENTION

Powder coating compositions are described herein which comprise an epoxy resin component, a curing agent component and optional additional additives. The epoxy resin component is produced from an epoxycycloaliphatic monomer. The curing agent is preferably either a thermally activated curing agent, such as a dicarboxylic acid, or a photo-initiated curing agent.

Embodiments of the present invention focus on epoxy resins formed from epoxycycloaliphatic monomers. A preferable embodiment is formed with the monomer 3,4-epoxycyclohexylmethyl methacrylate (also referred to herein as ACH CER 15). Resins formed from these monomers may be cured at low temperatures, 250 degrees F. (121 degrees C.) or below, and thus are suitable for coating heat sensitive substrates, such as plastics. Additionally, this disclosure identifies and uses azelaic acid as a thermally activated curing agent. Azelaic acid, a cross-linker with a melting point (mp) of 110 degrees C., allows thermosetting the resins at the new lower temperatures instead of the traditional prior art curing agent dodecanedioic acid (DDDA) which has a mp of 128 degrees C.

In accordance with this invention, powder coating compositions are provided that are capable of being cured at temperatures below about 120 degrees C. yet still are capable of providing cured coating properties comparable to those achieved with the high temperature curing of GMA-containing coating compositions.

In embodiments of the present invention, compositions useful for powder coatings are prepared from epoxy resins prepared from epoxycycloaliphatic monomers. The resin may also contain other additives such as flow modification agents, degassing agents and pigments.

All patents, published patent applications and articles referenced in this detailed description are hereby incorporated by reference in their entireties.

The use of the terms “a” and “an” is intended to include one or more of the element described. Lists of exemplary elements are intended to include combinations of one or more of the element described.

The term “may” as used herein means that the use of the element is optional and is not intended to provide any implication regarding operability.

For the purposes of this invention, the term curing agent means a chemical substance which brings about the toughening or hardening of a polymer material by cross-linking of polymer chains. It is inclusive of substances which must be activated by heat, light, ultraviolet radiation, electron beams or other energy sources. The term curing agent includes compounds that react with the functional groups of a given polymer to which they are applied to facilitate hardening, catalytic agents that promote reactions but do not themselves react with the polymer, and initiators that only begin the necessary hardening reactions but do not continue to react with the system. As used herein, the term cross-linker is synonymous with curing agent.

As used herein, a cross-link is a bond that links one polymer chain to another. They can be covalent bonds or ionic bonds. Cross-links can be formed by chemical reactions that are initiated by heat, pressure, change in pH, or radiation.

Where this disclosure references ASTM testing procedures, reference is to the version of the procedure that was in effect on Jan. 1, 2016.

The Epoxy Resin Component

The powder coating compositions of this invention comprise an epoxy resin component and a curing agent component. The epoxy resin component is produced from an epoxycycloaliphatic monomer (Component A) represented by the structure of general formula 1:

G-R² (1)

or general formula 2

or G-R¹—R² (2)

wherein G is a 3,4-epoxycycloaliphatic structure of 5 to 8 carbons in which the cycloaliphatic moiety may be unsubstituted or substituted with hydroxyl, halo (preferably Cl or Br), or alkyl groups of 1 to 3 carbons, and the ring structure may be saturated or contain an aliphatic unsaturation, R¹ is an aliphatic moiety of 1 to 3 carbons, and R² is represented by the structure of either general formula 3

—C(H)═CH₂, (3)

or general formula 4

—O—C(O)—(R³)C═CH₂ (4)

in which R³ is hydrogen or lower alkyl of 1 to 3 carbons, provided that the epoxycycloaliphatic monomer has a melting point less than 135 degrees C., preferably less than about 130 degrees C.

The epoxycycloaliphatic monomer (Component A) used in the compositions of this invention are characterized as having an epoxycycloaliphatic moiety as the glycidyl functionality. The cycloaliphatic moiety is preferably cyclopentane or, more preferably, cyclohexane. Component A also has a reactive aliphatic unsaturation provided by a vinyl group. In some instances, the vinyl group can be incorporated into a carboxyl functional group, e.g., an acrylic, or substituted acrylic, functional group.

The preferred acrylic functional groups include acrylate, methacrylate, and ethyl acrylate. The acrylic functional group has the epoxycycloaliphatic in the ester moiety. An aliphatic moiety of one to three carbons, preferably methylene, bridges between the cycloaliphatic structure and the carboxylate group. The epoxycycloaliphatic monomer has a melting point less than about 135 degrees C. Often, the melting point of the epoxycycloaliphatic monomer is between about 100 degrees C. and 130 degrees C. The preferred epoxycycloaliphatic monomers are 3,4-epoxycyclohexylmethyl methacrylate (ACH CER 15), 3,4-epoxycyclohexylmethyl acrylate and 4-vinyl-1-cyclohexene 1,2-epoxide. The most preferred epoxycycloaliphatic monomer is 3,4-epoxycyclohexylmethyl methacrylate (ACH CER 15). The chemical structure of ACH CER 15 is represented by formula 5, below.

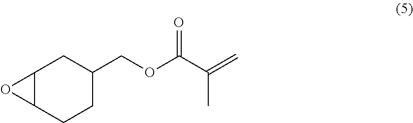

Thermal Curing Agent Component

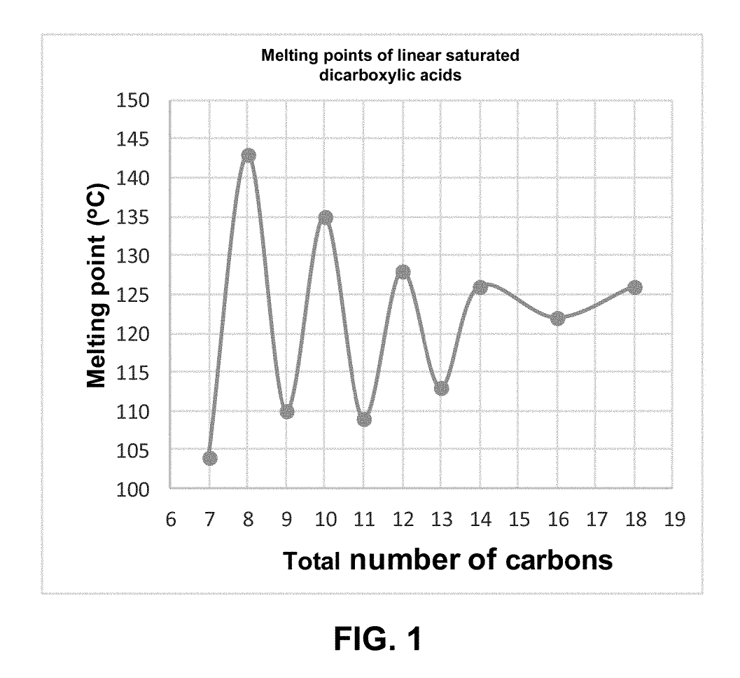

Suitable thermal curing agents for use in the present invention are aliphatic or aromatic dicarboxylic acids (Component B) having a melting point less than about 120 degrees C., preferably, less than about 115 degrees C. The melting points of linear saturated dicarboxylic acids is shown in FIG. 1. As shown in FIG. 1, linear saturated dicarboxylic acids with an even number of total carbons have higher melting points than those with an odd number of total carbons, at least when the range of total carbons is from 7 to 18. The total number of carbons for azelaic acid is nine and for DDDA is twelve. The up-and-down trend in the melting points of dicarboxylic acids was a phenomenon demonstrated elsewhere and is a direct consequence of molecular symmetry, even versus odd.

The dicarboxylic acid (Component B) may be aliphatic or aromatic and has a melting point of less than about 120 degrees C. Typically, Component B has a melting point between about 100 degrees C. and 130 degrees C. The dicarboxylic acid is represented by general formula 6:

HOC(O)—R⁴—C(O)OH (6)

wherein R⁴ is aliphatic, aromatic or dialkylaromatic of 4 to 12 carbons, with the proviso that if of an even number of carbons, R⁴ comprises either a cycloaliphatic or aromatic moiety. In one aspect of the invention, R⁴ is aliphatic of 5, 7 or 9 carbons. In another aspect of the invention R⁴ can be represented by general formula 7:

—R⁶— (7)

Or general formula 8:

—R⁵—R⁶—R⁷— (8)

wherein R⁶ is a cycloaliphatic group of 5 to 8 carbon atoms or a cyclopentadienyl group or phenyl group, R⁵ and R⁶ may be the same or different and are independently alkylene groups of 1 to 3 carbons. The preferred dicarboxylic acids are pimelic acid (heptadioic acid); azelaic acid (nonanedioic acid), and brassilic acid (undecanedioic acid). The most preferred dicarboxylic acid is azelaic acid (nonanedioic acid).

Photo-Initiated Curing Agent Component

Cationic photo-initiators (Component C) are used to induce the polymerization of cycloaliphatic epoxides and other cation polymerizable materials upon exposure to UV light of sufficient intensity to convert the photo-initiator into a reactive cation. As used herein, a photo-initiator is a molecule that creates reactive species, for example, free radicals, cations or anions, when exposed to sufficiently intense radiation (UV or visible). A cationic photo-initiator is one which creates a cation, e.g. a strong acid species, either a Lewis or Brönsted acid, that initiates polymerization.

UV LED lamps relative to traditional UV lamps offer longer useful life, targeted curing, and single spectrum outputs. Cationic photo-initiators are typically solid powders such as friaryl sulfonium hexafluoroantimonate salt, or diphenyl(4-phenylthio)phenylsulfonium hexafluorophosphate, or bis(4-methylphenyl)lodonium haxafluorophosphate, or (4-methylphenyl) (4-(2-methylpropyl)phenyl) iodonium hexafluorophosate, or diphenyl(4-phenylthio)phenylsulfonium hexafloroantimonate, or (thiodi-4,1-phenylene)bis(diphenylsulfonium) dihexafluoroantimonate, or a mixture of these photo-initiators thereof.

Powder Coating Compositions

Powder coating compositions according to embodiments of the present invention may be prepared to be cured using either a thermally activated curing agent or a photo-initiator which is activated upon exposure UV radiation. Powder coating compositions for thermal curing embodiments will preferably comprise Component A and Component B. Powder coating compositions for UV curing embodiments will preferably comprise Component A and Component C.

In compositions suitable for thermal curing, the mole ratio of Component A to Component B can vary. Preferably, the mole ratio of Component A to Component B in thermally cured embodiments is between about 1:10 to 10:1, more preferably from about 1:5 to 5:1.

In compositions suitable for photo-initiated curing, Component C is preferably present in the coating composition in the range of 0.1% to 15% by weight, more preferably 0.25% to 7% by weight, most preferably 0.5 to 5% by weight of the overall powder coating composition.

In addition to the components described above the compositions within the scope of the present invention can include one or more additives such as catalyst; fillers; flow control agents such as Modaflow, Acronal 4F, and Resiflow PVS; and the degassing agents such as benzoin. Stabilizing agents, antioxidants and treatments can also be utilized in the compositions of this invention.

The preparation of the powder coating may be effected in any suitable manner, but usually is provided by dry mixing then extruding the mixture to achieve a homogenous blend. The extrusion takes place at about 100 degrees C., but not under conditions which result in the undue curing of the composition. The extruding should be sufficient to provide contact among the components of the powder coating. The extruded material is typically ground to a powder within a particle size ranging from about 10 to 150 microns in major dimension.

The application of the composition to a substrate may be by any suitable means, including, but not limited to, an electrostatic corona gun or tribo gun. The applied coating is then cured, for example, at elevated temperature, or by exposure to radiation as described below.

The Thermal Curing Process

The powdered coating compositions of this invention are thermally cured at a temperature between about 70 degrees C. to 120 degrees C., more preferably between about 80 degrees C. to 110 degrees C. most preferably between about 80 degrees C. to 100 degrees C.

The curing is carried out in a fixed temperature oven for a duration ranging from about 3 minutes to about 2 hours, more preferably from about 7 minutes to about 1 hour, most preferably from about 10 min to about 30 min. The curing process is complete when the surface coating attains target values for performance properties such as adhesion and hardness. The optimal curing temperature and curing duration for a specific coating formulation and substrate can be determined using methods known to one of skill in the art.

Whether cured using radiation or heat, the preferred coatings of this invention exhibit a cross-cut adhesion on steel panels using ASTM procedure 3359, as in effect on Jan. 1, 2016, of at least 3B. The preferred coatings of this invention also exhibit a resistance to toluene rubs pursuant to ASTM procedure 4752, as in effect on Jan. 1, 2016, on steel panels of at least about 80, preferably at least about 100.

The Photo-Curing Process

For the powder compositions that include Component C, a cationic photo-initiator, the curing process is triggered by exposure to UV light in the range of 100 nm to 400 nm. The UV light may be provided by a lamp (e.g., a high-pressure mercury lamp, a mercury lamp, a high-pressure lamp, or any other suitable lamp) having a suitable voltage (e.g., a voltage of approximately 400 V, or about 100-700 V, or about 200-600 V, or about 300-500 V, or about 350-450 V, or any other suitable voltage); a suitable intensity (e.g., a intensity of about 100 mW/cm2, or about 1 1000 mW/cm2, or about 5-500 mW/cm2, or about 10-400 mW/cm2, or about 25-300 mW/cm2, or about 50-200 mW/cm2, or about 60-150 mW/cm2, or about 75-125 mW/cm2, or any other intensity strength).

The curing process is complete when the surface coating attains target values for performance properties such as adhesion and hardness. Variables affecting the curing process, include the duration of the exposure, and the distance of the UV source to the curing surface. The optimization of these variables for a specific coating formulation and substrate can be determined using methods known to one of skill in the art.

Whether cured using radiation or heat, the preferred coatings of this invention exhibit a cross-cut adhesion on steel panels using ASTM procedure 3359, as in effect on Jan. 1, 2016, of at least 3B. The preferred coatings of this invention also exhibit a resistance to toluene rubs pursuant to ASTM procedure 4752, as in effect on Jan. 1, 2016, on steel panels of at least about 80, preferably at least about 100.

### EXAMPLES

To demonstrate embodiments of the present invention, liquid coatings were prepared and tested. Although the methods of application to the substrate are different for liquid coatings and powder coatings, it is expected that the coatings will perform similarly once applied and cured. A reference resin was prepared from GMA and a resin was prepared from 3,4-epoxycyclohexylmethyl methacrylate (ACH CER 15) with equal solid percentages, epoxy equivalent weights (EEW), and glass transition temperatures (Tg). Coatings were then prepared using those resins as described below. Results from standard coating application tests are discussed below and clearly show that 3,4-epoxycyclohexylmethyl methacrylate (ACH CER 15) resin at 90 degrees C. and at 80 degrees C. cured and consequently adhered and resisted cracking significantly better than the GMA-resin. These lower curing temperatures were realized with the identification and use of azelaic acid. Azelaic acid at 100 degrees C. and below yielded crosslinked films cured to higher degrees than DDDA.

Chemicals

The chemicals used to produce the epoxy resins were toluene (ACS reagent, ≧99.5%), glycidyl methacrylate (GMA, ≧99.0%), 3,4-Epoxycyclohexylmethyl methacrylate (ACH CER 15, ≧95.0%), methyl methacrylate (≧99.0%), styrene (≧99.0%), n-Butyl methacrylate (≧99.0%), and Di-t-amyl peroxide (≧96.0%). The chemicals used to prepare the coatings in addition to the two made resins were dodecanedioic acid (DDDA, 99%), azelaic acid (AA, 98%), 1-Methyl-2-Pyrrolidinone (NMP, ≧99.0%), Modaflow® 9200 (acrylic flow modifier), and benzoin (98%).

Equipment

The synthesis apparatus used to make the resins consisted of a 1 L 4-neck round bottom flask, an Apollo temperature controller with J-type thermocouples, 24/40 joint thermocouple adapter, two counter current condensers, S type 24/40 joint adapter, metal 1 L heating mantle, 500 ml addition funnel with equalizer side arm, N2 tank with regulator, 2 glass hose adapters for N2 blanketing, bubbler filled with silicon oil, Polyscience cooling unit (PN:9102A11B), long stem funnel, Teflon sleeves, Heidolph (RZR 2041) electrical stirrer with glass stirring rod and paddle, and 29/42 joint adapter for stirring shaft to round bottom flask. The small parts of the apparatus were cleaned individually with toluene. The 1 L 4-neck round bottom flask was cleaned by stirring and refluxing 300 mL of toluene for 30 min.

Making the Epoxy Resins

The steps listed below employ the concentrations and corresponding chemical amounts listed in Table 1 for making a total of 450 g per resin per batch with a target solid of 50.5%.

TABLE 1
Compositions of the epoxy resins

| | GMA-resin | | ACH CER 15-resin | |
|---|---|---|---|---|
| Chemical | (wt %) | 450-g batch (g) | (wt %) | 450-g batch (g) |
| Initial toluene | 44.50 | 200.23 | 44.50 | 200.23 |
| GMA | 14.25 | 64.13 | 0.00 | 0.00 |
| ACH CER 15 | 0.00 | 0.00 | 19.67 | 88.51 |
| Methyl methacrylate | 14.17 | 63.76 | 13.33 | 60.00 |
| Styrene | 13.75 | 61.88 | 12.58 | 56.63 |
| n-Butyl methacrylate | 7.83 | 35.25 | 4.42 | 19.88 |
| Di-t-amyl peroxide | 0.50 | 3.38 | 0.50 | 3.38 |
| Flush toluene | 5.00 | 22.50 | 5.00 | 22.50 |
| Total | 100.00 | 450.00 | 100.00 | 450.00 |
| Calculated Solids | 50.50 | 227.27 | 50.50 | 227.27 |

Preparation of Epoxy Coatings

The studied coatings consisted of the GMA-resin and the ACH CER 15 resin, a cross-linker solution, Modaflow 9200 and benzoin and were prepared according to the concentrations shown in Table 2.

TABLE 2
Compositions of coatings

| | Coating | Coating | Coating |
|---|---|---|---|
| | GMA- | GMA-resin | ACH CER |
| | resin | (wt %) | 15-resin (wt %) |
| | (wt %) | [Azelaic | [Azelaic |
| Material | [DDDA] | acid] | acid] |
| GMA-Resin | 47.56 | 52.35 | 0 |
| CER 15-Resin | 0 | 0 | 53.82 |
| Cross-linker Solution | 50.81 | 0 | 0 |
| (DDDA at 20 wt % and | | | |
| NMP at 80 wt %) | | | |
| Cross-linker Solution | 0 | 45.86 | 44.33 |
| (azelaic acid at 20 wt % | | | |
| and NMP at 80 wt %) | | | |
| Modaflow ® 9200 | 1.34 | 1.47 | 1.52 |
| Benzoin | 0.29 | 0.32 | 0.33 |
| Total | 100.00 | 100.00 | 100.00 |
| Calculated Solids | 35.81 | 37.40 | 37.89 |

The binary cross-linker solutions consisted of the cross-linker at 20 wt % and 1-methyl-2-pyrrolidinone (NMP) as the solvent at 80 wt % and were prepared.

Results and Discussion

The compositions were determined and set in order to obtain resins with equal solids, T_{g} and EEW. For both resins the measured solids agreed perfectly with the theoretical solids and the differences between the calculated and measured EEW were 6% or less. The measured EEW of the two resins differed only by 7%. The estimated T_{g} were calculated using the Fox Equation. The Flory-Fox equation relates the number-average molecular weight, Mₙ, to the glass transition temperature, T_{g}, as shown below:

$${T}_{g} = {T}_{g , ∞} - \frac{K}{{M}_{n}}$$

where T_{g,∞} is the maximum glass transition temperature that can be achieved at a theoretical infinite molecular weight and K is an empirical parameter that is related to the free volume present in the polymer sample.

TABLE 3
Properties of produced epoxy resins

| | GMA- | ACH CER |
|---|---|---|
| Property | resin | 15-resin |
| Appearance | Clear colorless | Clear colorless |
| | liquid | liquid |
| Color (APHA) | <40 | <40 |
| Calculated Solids | 50.5% | 50.5% |
| Measured Solids | 50.9% | 50.8% |
| Density (21 | 0.99 | 0.98 |
| degrees C), g/mL | | |
| Viscosity (21 | 4420 | 5260 |
| degrees C), cP | | |
| Calculated EEW, | 1003 | 1042 |
| g/eq. | | |
| Measured EEW, | 1035 | 1111 |
| g/eq. | | |
| Estimated Tg | 70 | 70 |
| (degrees C) | | |

The resulting liquid coatings from both resins were clear colorless and their theoretical and measured solids agreed. Azelaic acid, a cross-linker with a melting point (mp) of 110 degrees C., was identified and used to allow thermosetting the coating films below 100 degrees C. instead of dodecanedioic acid (DDDA, mp=128 degrees C.).

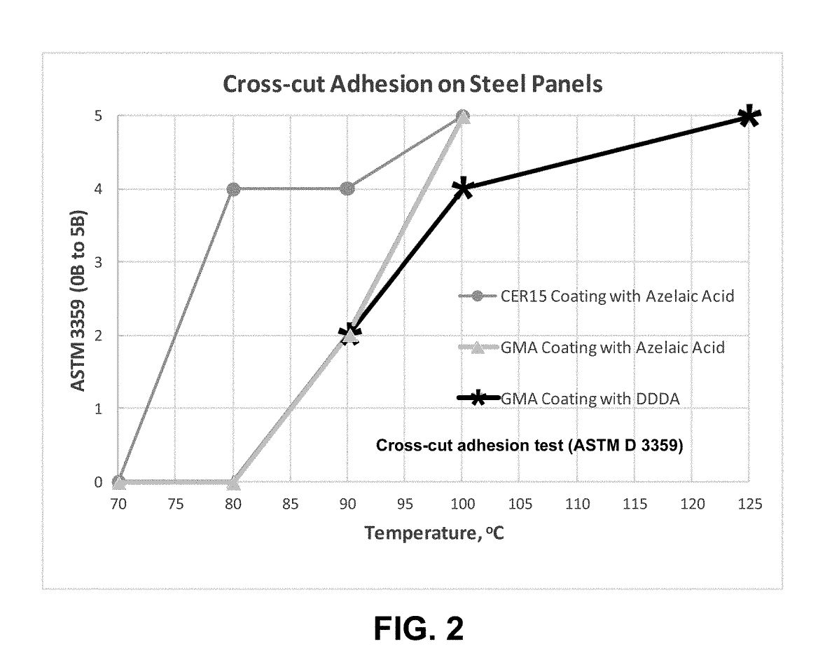

The results in FIG. 2 were obtained using the cross-cut adhesion test (ASTM D 3359) and clearly show that the adhesions of the CER 15 coatings were significantly higher at 90 degrees C. and 80 degrees C. than the adhesions of the GMA coatings. In this standard test, the best result is a 5B and the poorest result is a OB. The data also show that azelaic acid at 100 degrees C. and below yielded more adhesive or crosslinked films than DDDA due to its lower melting point. All the coatings discussed in this paper were put in an oven for 30 min at fixed temperatures (the x-axis of the graphs included in this part) and the resulting dried films were 2.5 mil (or 63.5 μm) as measured using a digital coating thickness meter CM-8822. The cutter spacing was 2 mm, recommended for dried film thickness of 60 to 120 μm.

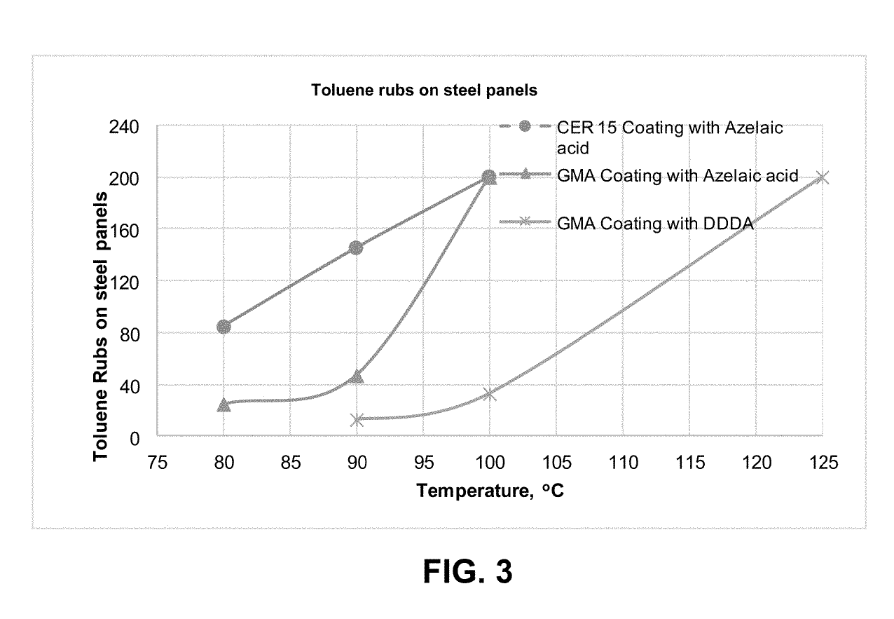

Based on results from toluene rubs, shown in FIG. 3, CER 15 coatings cured to higher degrees than the GMA coatings at 90 degrees C. and 80 degrees C. Toluene is the solvent in which the resins were made and is present in the resin solutions. The highest number in this figure is 200 rubs since the experiments were stopped at 200 rubs. Furthermore, these results also show that azelaic acid at 100 degrees C. and below yielded crosslinked films with higher cured degrees than DDDA, again owing to its lower melting point.

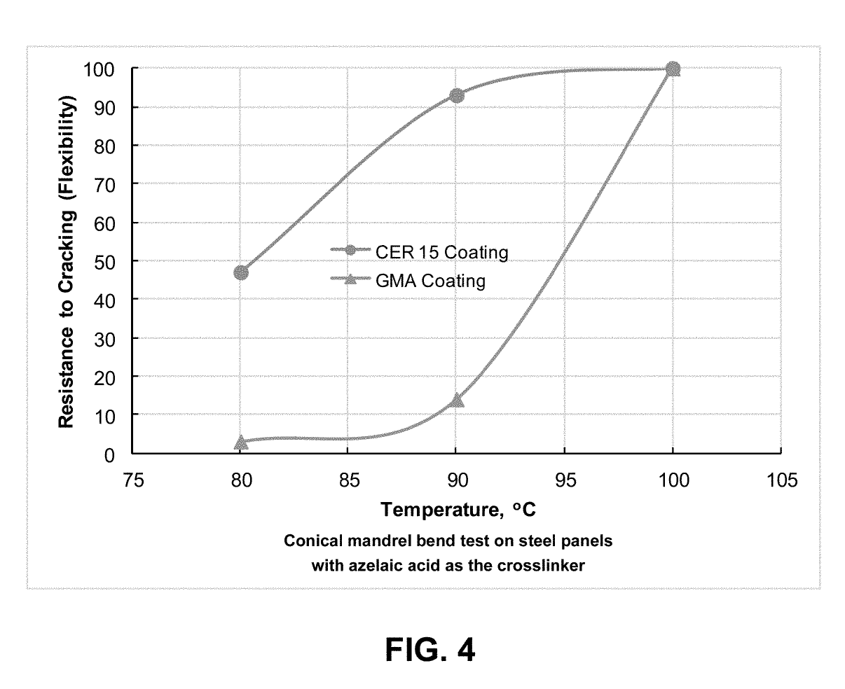

Results obtained using the conical mandrel bend test (ASTM D 522), FIG. 4, show that CER 15 coatings resisted cracking considerably more favorably than the GMA coatings at 90 degrees C. and 80 degrees C.

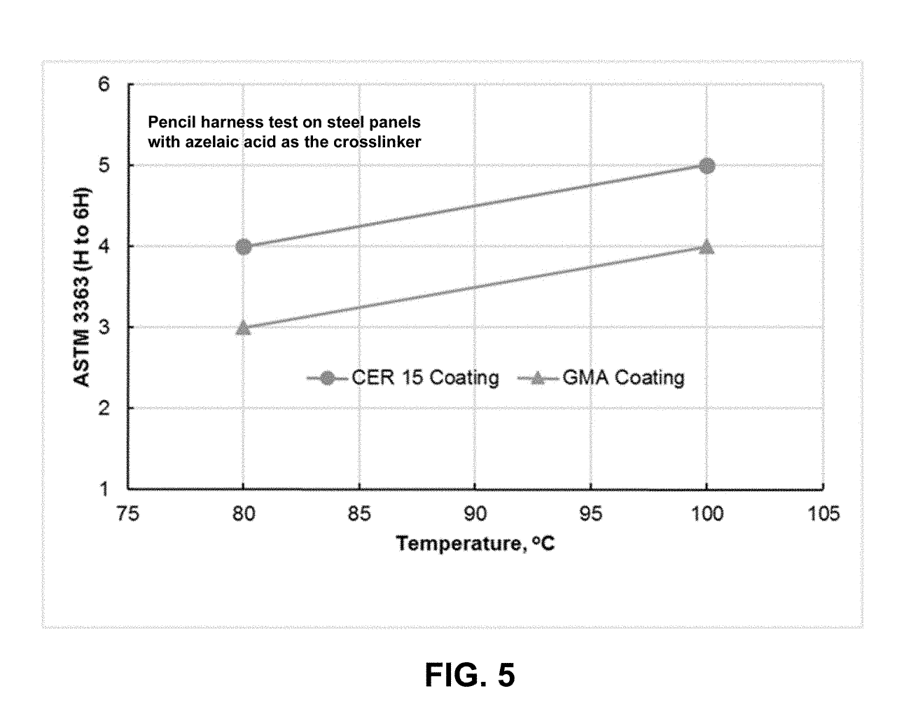

Pencil hardness (ASTM D 3363) results (FIG. 5) indicated that CER 15 coatings were somewhat harder than GMA coatings at 100 degrees C. and 80 degrees C.

The results clearly established that ACH CER-15-resin cured at 90 degrees C. and at 80 degrees C. cured, and consequently adhered and resisted cracking, significantly better than the GMA-resin. Also, azelaic acid at 100 degrees C. and below yielded crosslinked films cured to higher degrees than DDDA, attributable to its lower melting point.

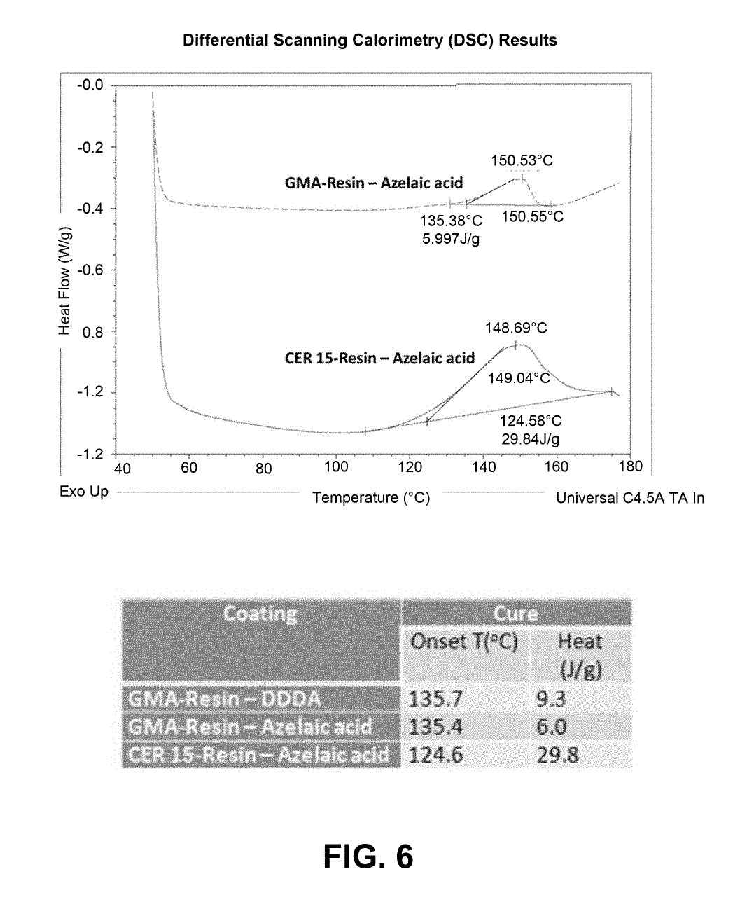

The results of differential scanning calorimetry analyses for the ACH CER-15 resin—azaleic acid composition and the GMA resin-azaleic acid composition are shown in FIG. 6. The lower onset temperature and larger evolved heat of the ACH CER-15 composition is attributed to the higher ring strain of the epoxide of the CER 15-resin relative to the ring strain of the epoxide of the GMA-resin. In other testing, CER 15 coatings consistently yielded the lowest onset temperature and largest heat of curing relative to GMA coatings made with azelaic acid or DDDA.

In summary, one GMA-resin and one CER 15-resin were made, having equal solid percentages, epoxy equivalent weights (EEVV), and glass transition temperatures (Tg). Coatings were then prepared using those resins. The results from standard coating application tests clearly show that the ACH CER-15 resin cured at 90 degrees C., and at 80 degrees C., cured, and consequently adhered, and resisted cracking significantly better than the GMA-resin cured at the same temperatures. Additionally, azelaic acid was selected and proven to allow thermosetting the films at the newly determined lower temperatures, instead of dodecanedioic acid.

1. A composition comprising:
an epoxy resin comprising at least one epoxycycloaliphatic monomer represented by a structure selected from the group consisting of:
G-R² and G-R¹—R²,
wherein G is a 3,4-epoxycycloaliphatic structure comprising a cycloaliphatic moiety of 5 to 8 carbons, wherein the cycloaliphatic moiety is unsubstituted or substituted with a substituent selected from the group consisting of hydroxyl, halo, and alkyl of 1 to 3 carbons, R¹ is an aliphatic moiety of 1 to 3 carbons, and R² is selected from the group consisting of —C(H)═CH₂ and —O—C(O)—(R³)C═CH₂, wherein R³ is hydrogen or an alkyl group of 1 to 3 carbons, wherein the at least one epoxycycloaliphatic monomer comprises a monomer melting point, wherein the monomer melting point is less than 135 degrees C.; and
a curing agent.

2. The composition of claim 1, wherein the curing agent comprises a dicarboxylic acid comprising a dicarboxylic acid melting point, wherein the dicarboxylic acid melting point is less than 120 degrees C.

3. The composition of claim 2, wherein the mole ratio of the at least one epoxycycloaliphatic monomer to the dicarboxylic acid ranges from 1:10 to 10:1.

4. The composition of claim 3, wherein the mole ratio of the at least one epoxycycloaliphatic monomer to the dicarboxylic acid is between 1:5 to 5:1.

5. The composition of claim 1, wherein the at least one epoxycycloaliphatic monomer comprises at least one selected from the group consisting of 3,4-epoxycyclohexylmethyl methacrylate, 3,4-epoxycyclohexylmethyl acrylate and 4-vinyl-1-cyclohexene 1,2-epoxide.

6. The composition of claim 2, wherein the dicarboxylic acid comprises azelaic acid.

7. The composition of claim 6, wherein the at least one epoxycycloaliphatic monomer comprises 3,4-epoxycyclohexylmethyl methacrylate.

8. The composition of claim 1, wherein the curing agent comprises a cationic photo-initiator, the cationic photo-initiator comprising a photo-initiator melting point, wherein the photo-initiator melting point is less than 130 degrees C.

9. The composition of claim 8, wherein the cationic photo-initiator comprises from 0.25% to 15% by weight of the composition.

10. The composition of claim 9, wherein the cationic photo-initiator comprises from 0.5% to 7% by weight of the composition.

11. The composition of claim 1, wherein the composition comprises at least one selected from the group of flow modifiers, degassing agents, pigments, catalysts, stabilizing agents and antioxidants.

12. A process for powder coating a substrate comprising:
applying, in powder form, the composition of claim 1 to the substrate to create a coating; and
curing the coating.

13. The process of claim 12, wherein the curing step comprises heating the coating to a temperature between 70 degrees C. and 120 degrees C. for a time sufficient to cure the coating.

14. The process of claim 12, wherein the heating step comprises heating the coating to a temperature between 80 degrees C. and 110 degrees C. for a time sufficient to cure the coating.

15. The process of claim 12, wherein the curing step comprises exposing the coating to ultraviolet radiation of sufficient intensity to activate a cationic photoinitiator, the ultraviolet radiation comprising light in a wavelength, range from 100 nm to 400 nm, for a time sufficient to cure the coating.

16.-20. (canceled)

21. A method for making a composition, comprising:
a.) mixing an epoxy resin in dry powder form with a curing agent in dry powder form to produce a mixture; wherein the epoxy resin comprises:
at least one epoxycycloaliphatic monomer represented by a structure selected from the group consisting of:
G-R² and G-R¹—R²,
wherein G is a 3,4-epoxycycloaliphatic structure comprising a cycloaliphatic moiety of 5 to 8 carbons, wherein the cycloaliphatic moiety is unsubstituted or substituted with a substituent selected from the group consisting of hydroxyl, halo, and alkyl of 1 to 3 carbons, R¹ is an aliphatic moiety of 1 to 3 carbons, and R² is selected from the group consisting of —C(H)═CH₂ and —O—C(O)—(R³)C═CH₂, wherein R³ is hydrogen or an alkyl group of 1 to 3 carbons, wherein the at least one epoxycycloaliphatic monomer comprises a monomer melting point, wherein the monomer melting point is less than 135 degrees C.,
b.) heating the mixture to a first temperature to form an uncured homogenous mixture, the first temperature being sufficient to melt at least one of the epoxy resin and the curing agent;
c.) forming an uncured powder that consists of the uncured homogenous mixture.

22. The method of claim 21, wherein step a) further comprises mixing the epoxy resin with a curing agent selected from the group consisting of dicarboxylic acids and cationic photoinitiators.

23. The method of claim 21, wherein step (b) further comprises: heating and extruding the mixture to form the uncured homogenous mixture.

24. The method of claim 23, wherein step (b) comprises extruding the mixture at the first temperature the uncured homogenous mixture, the first temperature being in a range from 90 degrees C. to 110 degrees C.

25. The method of claim 24, wherein step (c) further comprises:
(c)(i) rolling the uncured homogenous mixture to produce a sheet;
(c)(ii) cooling the sheet;
(c)(iii) breaking the sheet into chips;
(c)(iv) grinding the chips into the uncured powder.
